(19) United States
(12) Patent Application Publication
(10) Pub. No.: US 2011/0241355 A1
(43) Pub. Date: Oct. 6, 2011

(54) ASSEMBLY FOR THE USE OF ALTERNATIVE ENERGY

(76) Inventor: Egon Frommherz, Steinen (DE)

(21) Appl. No.: 12/998,889

(22) PCT Filed: Dec. 10, 2009
(86) PCT No.: PCT/DE2009/001746

§ 371 Date: Jun. 13, 2011

(30) Foreign Application Priority Data
Dec. 13, 2008 (DE) 20 2008 016 531.8

(51) Int. Cl. H02K 7/18; F03G 7/10

(52) U.S. Cl. 290/1 D; 74/DIG. 9

(57) ABSTRACT

In a novel assembly for the use of alternative energy, an even number of weights (5) is suspended symmetrically and outside of the center thereof on the outer circumference of a drive wheel (3); with respect to the direction of rotation (F) of the drive wheel (3), a support (12) for the respective weight (5) is fastened to the drive wheel (3) behind each weight (5), and each weight (5) is drivingly connected to the main drive shaft (4) of a generator (15); the drive wheel (3) is additionally drivingly connected to the output shaft (20) of the drive motor (14). Once the drive wheel (3) has been started to rotate by the drive motor (14), the weights (5) moving downward during the rotation drop down due to the gravity thereof in a pendulum fashion and drive the main drive shaft (4), and the energy that is created by this is transmitted to the generator (15), from where it can be picked up in the form of electricity; the weights (5) moving upward during the rotation strike against the supports (12) thereof and come to a standstill.

The invention relates to an assembly for the use of alternative energy.

Previous proposals for apparatuses for the use of alternative energy relate to solar energy, wind energy, water power, tidal power, and geothermal power. No proposal is known for an apparatus for the use of gravitation or the force of gravity.

The object of the invention is to provide an assembly which makes it possible to convert the force of gravity to usable energy, for example in the form of electrical power; in this case, as high a utilization level or efficiency as possible is desired.

According to the invention, this is achieved by an assembly as claimed in claim 1.

According to the invention, an even number of weights are suspended symmetrically, and oscillating off-center on the external circumference of a drive wheel; a rest for the relevant weight is attached to the drive wheel behind each weight, with respect to the rotation direction of the drive wheel and each weight is connected for drive purposes to the main drive shaft of a generator; the drive wheel is also connected for drive purposes to the output drive shaft of a drive motor. Once the drive wheel has been moved by the drive motor, then those weights which are moved downward during rotation fall downward in an oscillating manner as a result of the gravitational force on them, and drive the main drive shaft, and the energy which is produced in this case is transmitted to the generator, from which it can be tapped off in the form of electricity; those weights which are moved upward during rotation strike their rests, and in doing so come to rest. The off-center suspension of the weights results in a lever-arm ratio on the weights which are moved downward and upward, which results in the majority of the energy which can be tapped off on the generator, for example approximately 80%, being available for external use, and only the minority, in the example about 20%, being consumed by the drive motor, in order to maintain the rotation of the drive wheel.

Preferably, eight weights are suspended uniformly and symmetrically, in an oscillating manner, on the external circumference of the drive wheel. This results in good smooth running and good efficiency of the assembly.

Each of the weights preferably has an off-center attachment on which it is suspended, in an oscillating manner, on the external circumference of the drive wheel, with the aid of a drive shaft.

According to one preferred embodiment, the drive wheel has an even number of arms which project symmetrically in the form of a star and at whose ends the weights are each suspended, in an oscillating manner, with the aid of a drive shaft. In this case, each arm of the drive wheel may then have a projection at its end, which projection faces in the opposite direction to the rotation direction of the drive wheel and on which the rest is provided for the weight, which is suspended, in an oscillating manner, on this arm. The star shape of the drive wheel results in a lightweight assembly design, and therefore improved efficiency of the assembly, as well.

Preferably, the drive wheel has eight arms which project symmetrically in the form of a star and at each of whose ends one of the weights is suspended, in an oscillating manner, and to each of whose ends a rest for the weight is attached.

The drive connection between the weights and the main drive shaft can preferably consist of chain drives, and the main drive shaft can also be connected via a chain drive to the drive shaft of the generator; the output drive shaft of the drive motor can be connected via a plurality of chain drives with a step-down ratio to the drive wheel.

Other power transmission elements, such as gearboxes, belts, jointed shafts, may also be used for this purpose.

The power is preferably transmitted from each weight to the main drive shaft with the aid of a chain drive and of a sprocket wheel tooth, which is mounted on the main drive shaft, via a clamping freewheeling mechanism, which is mounted on the main drive shaft. The clamping freewheeling mechanism ensures that the weights do not influence and disturb one another during their oscillating movement and when stationary.

The invention will be described in more detail in the following text with reference to one preferred embodiment; in the figures:

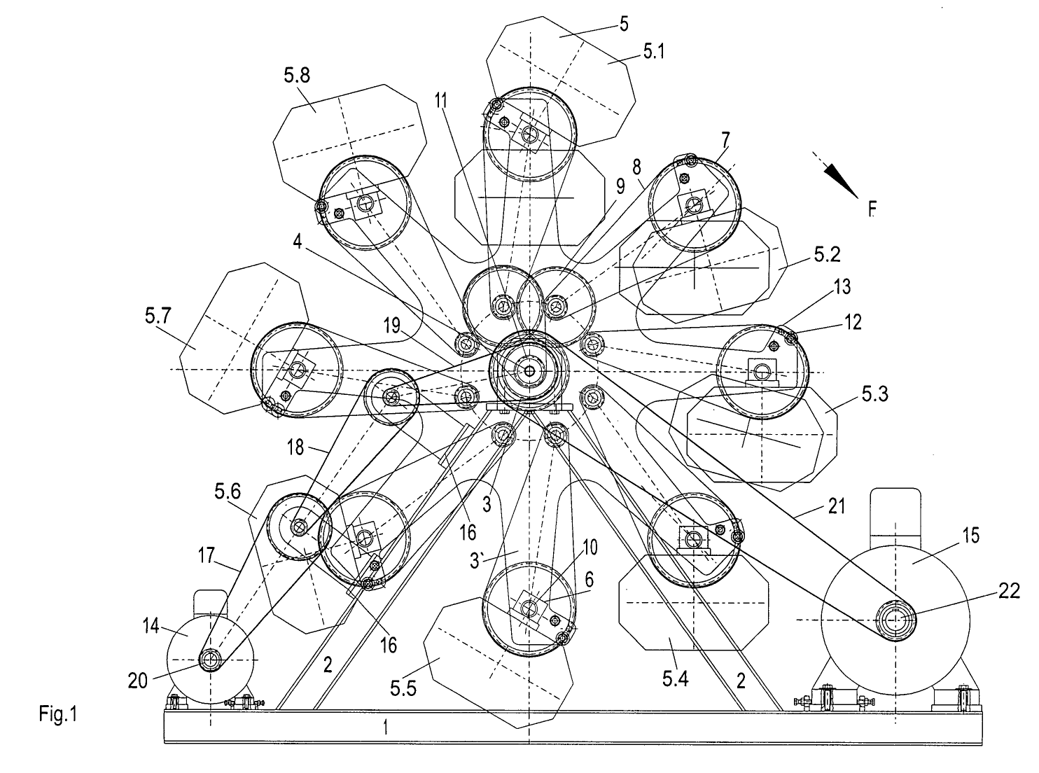

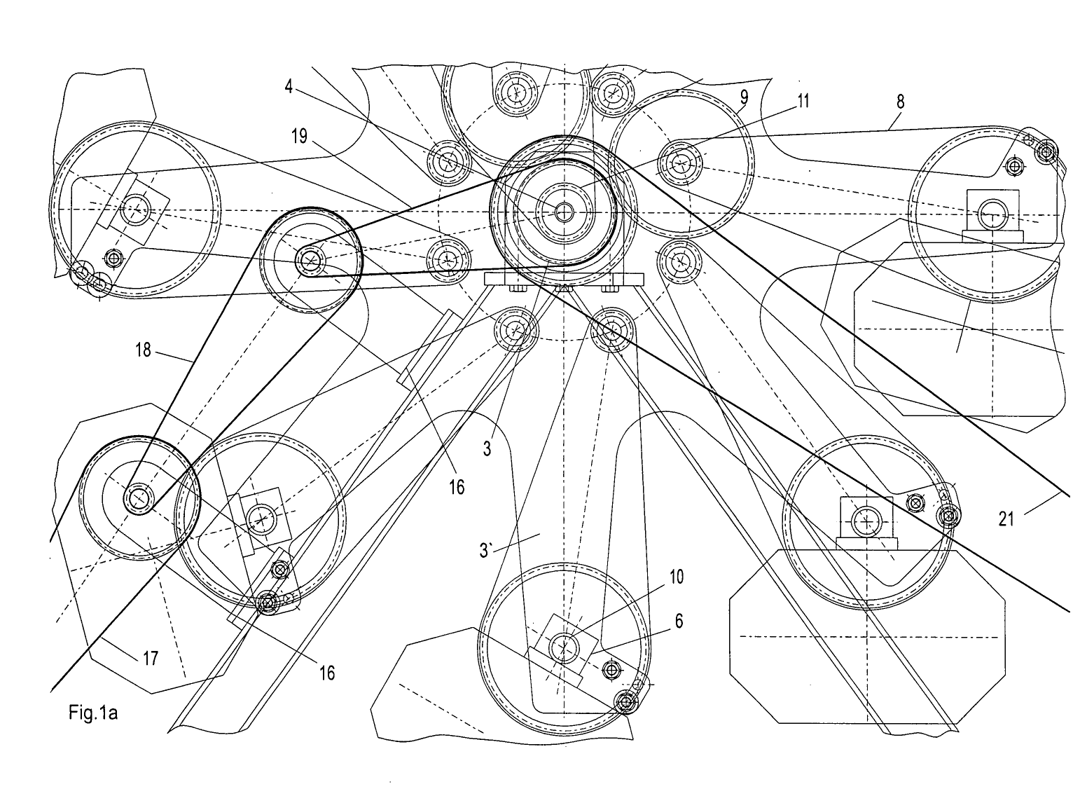

FIG. 1 shows the front view of an assembly according to the invention,

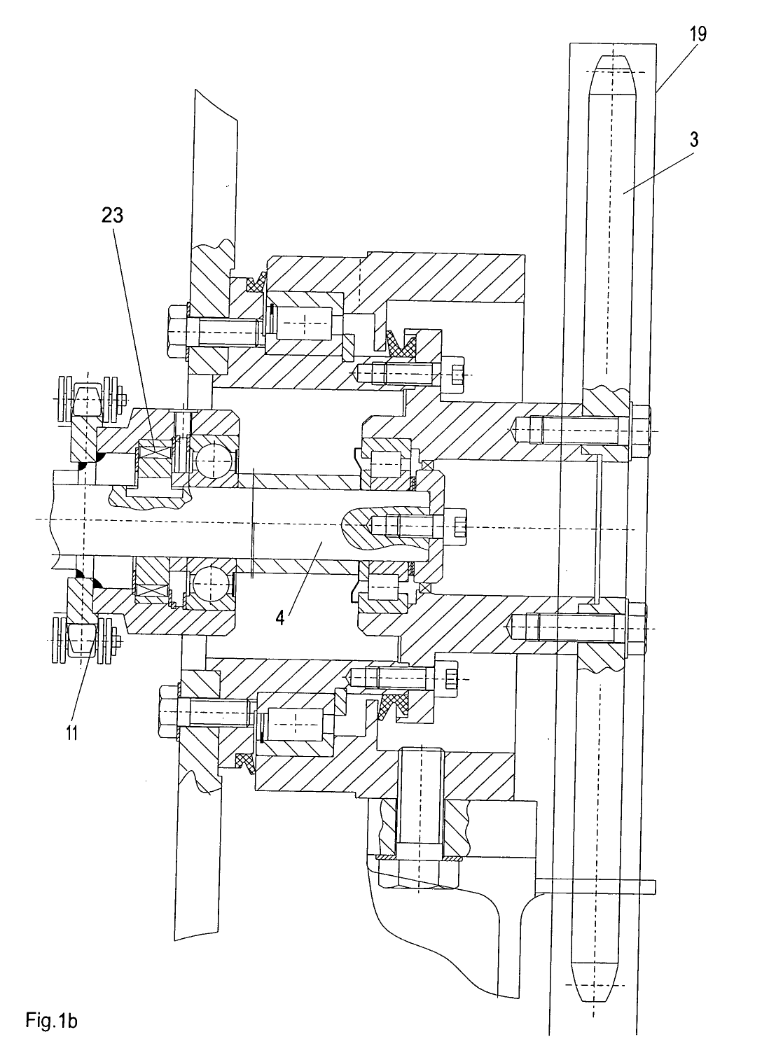

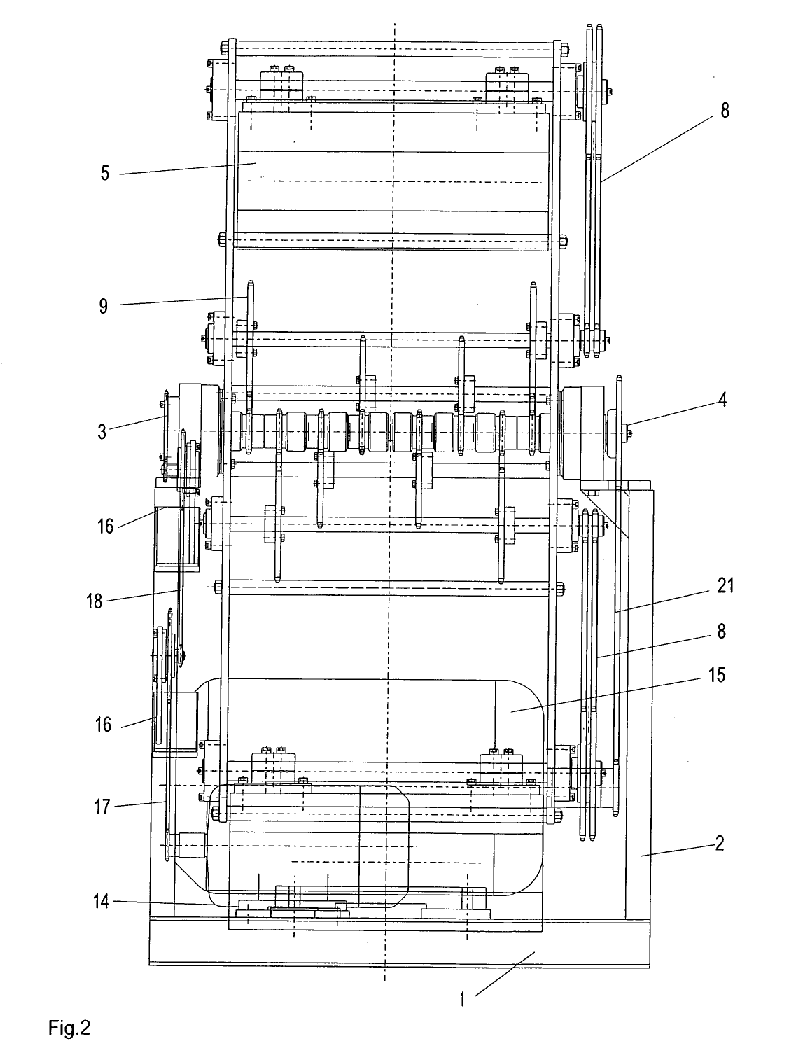

FIG. 2 shows the side view of the assembly as shown in FIG. 1, in the direction of the arrow P in FIG. 1,

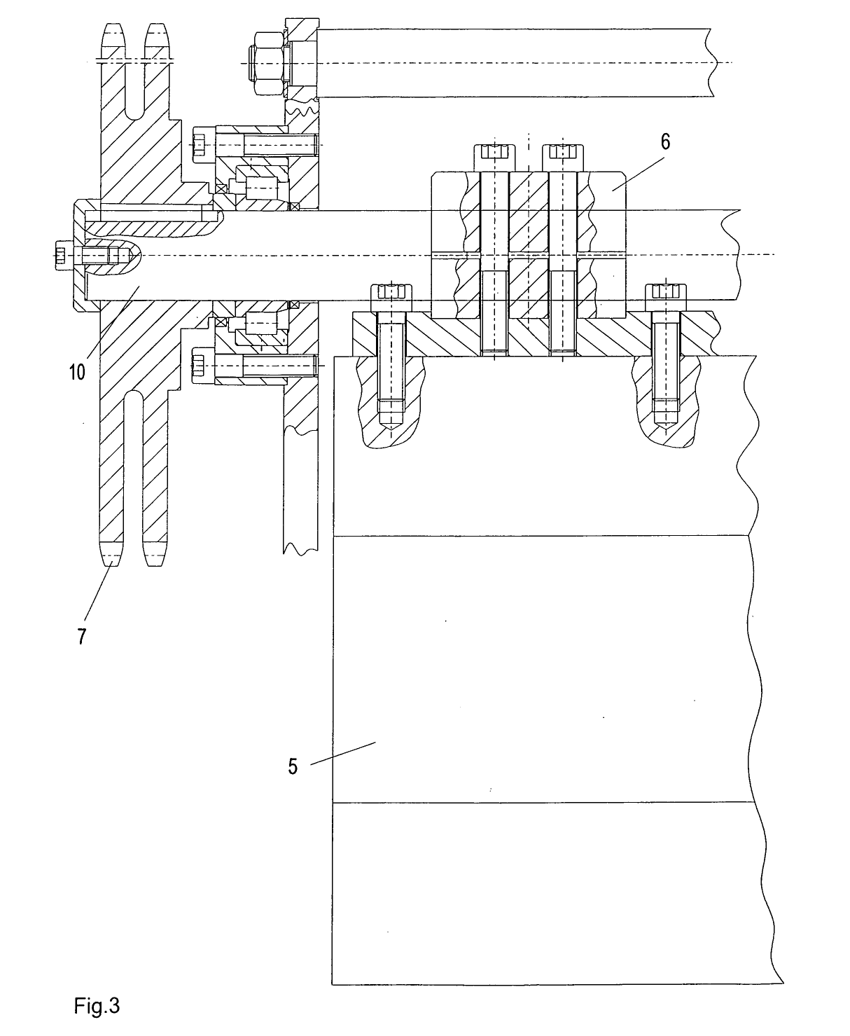

FIG. 3 shows a side view of the bearing of the weights which are used in the assembly shown in FIG. 1, using the example of a single weight, partially sectioned,

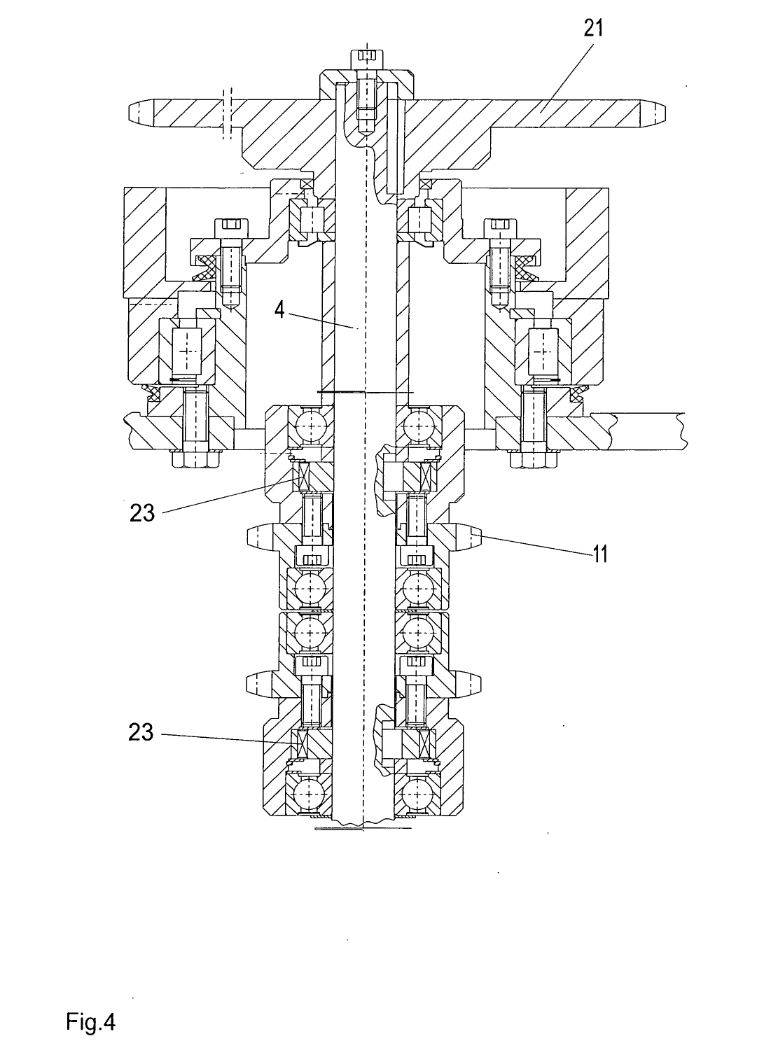

FIG. 4 shows a section view of a part of the bearing on the main drive shaft of the assembly shown in FIG. 1, and

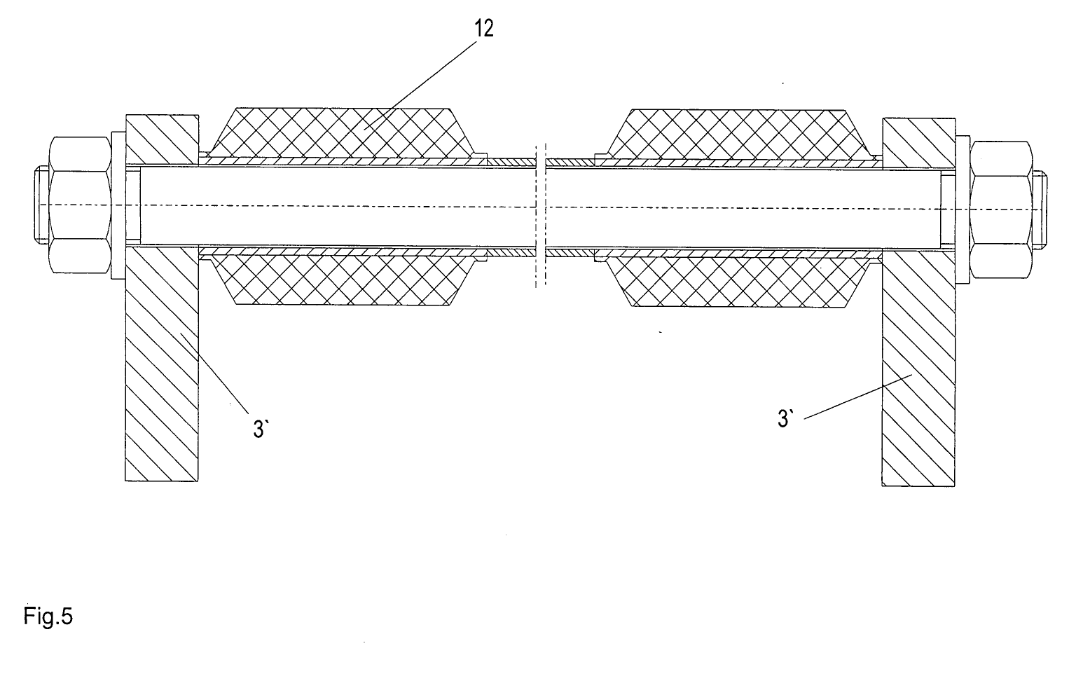

FIG. 5 shows a side view, partially sectioned, of the rest for the weights of the assembly as shown in FIG. 1.

As is shown in FIG. 1, a multi-arm drive wheel 3 is mounted by means of cross members 2 on a base frame 1, and is mounted separately on the cross members 2 such that it can rotate; in the illustrated embodiment, the drive wheel 3 has a total of eight arms 3′ which project symmetrically in the form of a star. Weights 5 are mounted at the ends of the arms 3′, symmetrically but off-center, such that they can rotate and/or oscillate. As is shown in FIGS. 1 and 3, the weights 5 for this purpose each have an attachment 6, on which the bearing is provided. Each weight 5 is firmly connected to a drive shaft 10, and a sprocket wheel 7 of a chain drive 8 is also mounted on the drive shaft 10 of each weight 5, and is firmly connected to the drive shaft 10, and therefore also to the relevant weight 5.

Each chain drive 8 has a further sprocket wheel 9, and all the sprocket wheels 9 engage with central sprocket wheel teeth 11, which are connected for drive purposes by means of the main drive shaft 4 to the drive shaft 22 of a generator 15. A rest 12 for each weight 5 is attached to the end of the relevant arm 3′ and is located behind the respective weight with respect to the rotation direction F of the drive wheel 3 (see also FIG. 5). As is shown in FIG. 1, the arm 3′ for this purpose has a projection 13 which is in the form of a tab and faces in the opposite direction to the rotation direction F of the drive wheel 3, to which projection 13 the rest 12 is attached.

Furthermore, a drive motor 14 and the generator 15 are mounted firmly on the base frame 1. Pedestal bearings 16 are mounted on the cross member 2 adjacent to the drive member 14 and are fitted with sprocket wheels with further chain drives 17, 18, 19. These chain drives 17, 18, 19 connect the output drive shaft 20 of the drive motor 14 with a step-down ratio (1:50) to the drive wheel 3; the main drive shaft 4 is itself connected via a further chain drive 21 to the drive shaft 22 of the generator 15.

As is shown in FIG. 4, power is transmitted by the chain drive 7, 8, 9 of each weight 5 via the sprocket wheel teeth 11 to the main drive shaft 4 with the aid of a transmission element in the form of a clamping freewheeling mechanism 23. In this case, the rotation direction of the drive wheel 3 and the installation of the clamping freewheeling mechanisms 23 are matched to one another so as to ensure that, during operation of the assembly (see below), the weights 5 can move independently of one another, can fall and oscillate or can remain stationary, without influencing or disturbing one another.

The assembly or the drive wheel 3 is first of all moved by the drive motor 14 via the chain drives 17, 18, 19; the energy required to do this can come from a battery or a capacitor, which is connected to the generator 15. As soon as the drive wheel 3 starts to rotate in the direction of the arrow F in FIG. 1, the weights 5.1, 5.2, 5.3, 5.4 on those arms 3′ of the drive wheel 3 which are moving downward fall downward, initially in an oscillating manner, because of the force of gravity. The energy which is produced in the process is transmitted via the chain drive 21 to the generator 15, from which it can be tapped off in the form of electrical power. The weights 5.5, 5.6, 5.7, 5.8 on those arms 3′ which move upward strike their rest 12 and are thus driven while stationary until they successively reach the highest point of the rotary movement, after which they themselves once again fall downward in an oscillating manner. When the weights 5 on the arms 3′ which are moving upward come into contact with their rest 12, the lever arm from the center of gravity 24 of the weight 5 to the center of the main drive shaft 4 increases, while the weights 5 on the arms 3′ which are moving downward start to oscillate in the vertical, and therefore have a shorter lever arm from the center of the main drive shaft 4. The force difference which results from this (torque) is taken over by the drive motor 14 in order to maintain, the rotary movement of the drive wheel 3. The energy which is required by the drive motor 14 for this purpose amounts to about 20% of the energy transmitted from the weights 5.1, 5.2, 5.3, 5.4 via the drive wheel to the generator 15, and 80% of this energy is available for external use at the generator 15.

### LIST OF REFERENCE SYMBOLS

1 Base frame
2 Cross members
3 Drive wheel, 3′ arms
4 Main drive shaft
5 Weights
6 Attachment
7 Sprocket wheel (weight)
8 Chain drive (weight)
9 Sprocket wheel
10 Drive shaft
11 Sprocket wheel teeth
12 Rest
13 Projection in the form of a tab
14 Drive motor
15 Generator
16 Pedestal bearing
17 18 19 Chain drive (drive motor—drive wheel)
20 Output drive shaft
21 Chain drive (generator)
22 Drive shaft (generator)
23 Clamping freewheeling mechanism
24 Center of gravity

1. An assembly for the use of alternative energy, characterized in that an even number of weights (5) are suspended symmetrically, and oscillating off-center on the external circumference of a drive wheel (3), and a rest (12) for the relevant weight (5) is attached to the drive wheel (3) behind each weight (5), with respect to the rotation direction (F) of the drive wheel (3), in that each weight (5) is connected for drive purposes to the main drive shaft (4) of a generator (15), and the drive wheel (3) is connected for drive purposes to the output drive shaft (20) of a drive motor (14).

2. The assembly as claimed in claim 1, characterized in that eight weights (5) are suspended uniformly and symmetrically, in an oscillating manner, on the external circumference of the drive wheel (3), with the aid of a drive shaft (10).

3. The assembly as claimed in claim 1, characterized in that each weight (5) has an off-center attachment (6) on which it is suspended, in an oscillating manner, on the external circumference of the drive wheel (3), with the aid of a drive shaft (10).

4. The assembly as claimed in claim 1, characterized in that the drive wheel (3) has an even number of arms (3′) which project symmetrically in the form of a star and at whose ends the weights (5) are each suspended, in an oscillating manner, with the aid of a drive shaft (10).

5. The assembly as claimed in claim 4, characterized in that the drive wheel (3) has eight arms (3′) which project symmetrically in the form of a star and at whose ends the weights (5) are suspended, in an oscillating manner, with the aid of a drive shaft (10).

6. The assembly as claimed in claim 4, characterized in that each arm (3′) of the drive wheel (3) has a projection (13) at its end, which projection (13) faces in the opposite direction to the rotation direction of the drive wheel (3) and on which the rest (12) is provided for the weight (5), which is suspended, in an oscillating manner, on this arm (3′).

7. The assembly as claimed in claim 1, characterized in that the drive connection between the weights (5) and the main drive shaft (4) consists of chain drives (7, 8, 9), in that the main drive shaft (4) is connected via a chain drive (21) to the drive shaft (22) of the generator (15), and in that the output drive shaft (20) of the drive motor (14) is connected via a plurality of chain drives (17, 18, 19) with a step-down ratio to the drive wheel (3).

8. The assembly as claimed in claim 1, characterized in that the drive connection between the weights (5) and the main drive shaft (4) consists of belt drives, in that the main drive shaft (4) is connected via a belt drive to the drive shaft (22) of the generator (15), and in that the output drive shaft (20) of the drive motor (14) is connected via belt drives with a step-down ratio to the drive wheel (3).

9. The assembly as claimed in claim 1, characterized in that power is transmitted from each weight (5) to the main drive shaft (4) with the aid of a chain drive (7, 8, 9) and of a sprocket wheel tooth (11), which is mounted on the main drive shaft (4), via a clamping freewheeling mechanism (23), which is mounted on the main drive shaft (4).
